(19) United States
(12) Patent Application Publication
(10) Pub. No.: US 2014/0164282 A1
(43) Pub. Date: Jun. 12, 2014

(54) Enhanced augmented reality display for use by sales personnel

(71) Applicant: Stephen T. Asbury, Pasadena, CA (US)

(72) Inventor: Stephen T. Asbury, Pasadena, CA (US)

(73) Assignee: TIBCO Software Inc., Palo Alto, CA (US)

(21) Appl. No.: 13/830,993

(22) Filed: Mar. 14, 2013

Related U.S. Application Data
(60) Provisional application No. 61/735,479, filed on Dec. 10, 2012.

(51) Int. Cl. G06Q 30/02

(52) U.S. Cl. CPC G06Q 30/0201
USPC 705/345

(57) ABSTRACT

Employees of the sales and service industry have to deal with a lot of information regarding their customers and clients. Keeping all the information available and accessible is difficult, especially when only certain information is relevant to the sales and service employees while trying to assist customers and clients. The augmented reality system disclosed herein allows employees in the sales and service industry to have contextually relevant information about their customers and clients presented quickly and accurately to them using an augmented reality display device.

### CROSS-REFERENCE TO RELATED APPLICATIONS

The present application claims priority to U.S. Provisional Application No. 61/723,316 filed on Dec. 10, 2012, entitled “Enhanced Augmented Reality Display for Use By Sales Personnel,” which is incorporated herein by reference in its entirety.

### TECHNICAL FIELD

The present disclosure relates generally to augmented reality displays for use of sales personnel to provide enhanced services to retail, sales, and other end customers.

### BACKGROUND

Employees of the sales and service industry are responsible for taking care of the needs of their customers and clients. In the sales and service industry, sales are increased when sales employees “know their customer.” Salesmen and saleswomen will oftentimes build their own personal knowledge of facts about their best customers in order to prepare to offer the right product or service at the right time to their customers. Keeping track of customers and clients and their preferences is always a challenge. Customer loyalty programs have been developed by merchants in order to be able to gather relevant sales information on loyalty program members and to provide relevant direct mail or email advertising to program members.

### SUMMARY

Disclosed herein is an augmented reality system operable to be used by users including, but not limited to, employees of the sales and service industry to better assist customers and clients with their needs. The augmented reality system may take information that a retailer or salesperson might have available on a computer or in some other location and summarize that information to be presented in a context that would be beneficial to a sales or service employee working, for example, at a retail outlet. For example, if there is information about a particular customer it might be displayed with that customer and if there is information about a product, maybe that a customer might be interested in, this information may be juxtaposed above the product on an augmented reality display being viewed by the salesperson or it might be juxtaposed above the customer visible through the augmented reality display.

By juxtaposing specific information about customers and products, the information becomes more useful from a sales context than generic information displayed out of context. With the described embodiment, for example, the relevant information can be placed next to the things it applies to or at least the context it applies to instead of being placed, uncontextually, in a place where the employee would have to mentally move it over to place the information in the appropriate sales context. Allowing customer information and product information to be overlaid or juxtaposed with the real customer, so that the employees can see things in context with the customer right there in real time and in proper context, may give the employee of the sales or service industry leverage to use the contextually relevant information to stay knowledgeable about their customers and in turn give their customers an enhanced experience.

To receive the enhanced shopping and service experience offered by the employees using the augmented reality, the customer could opt-in to the loyalty program for the particular store or service. Customers may also become enrolled in a particular company's loyalty program if they have been previously enrolled in another company's loyalty program. Such loyalty information could be shared between companies allowing loyalty customers with one company to automatically become enrolled in another company's loyalty program, enhancing the customer's experiences at multiple locations for different companies. A loyalty customer could also become a member of a particular company's loyalty program by being a member of a social media site such as Facebook or tibbr, the latter being TIBCO's enterprise social enterprise networking application.

The customer could be noticed by the store's sensors for having an associated social media application on their portable device. The information given to the social media site could then be used to gather information on the customer to enhance the customer's shopping or service experience. Another possible way for a customer to become registered with a particular company's loyalty program is to not only have the loyalty information actively shared between several companies but to have the store go out and gather this information from other sites and other loyalty programs.

### BRIEF DESCRIPTION OF DRAWINGS

Reference is now made to the following detailed description of the preferred embodiments, taken in conjunction with the accompanying drawings. It is emphasized that various features may not be drawn to scale. In fact, the dimensions of various features may be arbitrarily increased or reduced for clarity of discussion. In addition, it is emphasized that some components be omitted in certain figures for clarity of discussion. Reference is now made to the following descriptions taken in conjunction with the accompanying drawings, in which:

FIG. 1 is a block diagram showing how an employee might be able to interact with a consumer using augmented reality and the consumer's loyalty information;

FIG. 2 is an architectural diagram showing the relationship of the loyalty site to the merchant headquarters, the consumer, and multiple merchants;

FIG. 3 is an architectural diagram demonstrating the store computer and the elements that could be associated with the store computer;

FIG. 4 shows an augmented reality display as viewed from an employee highlighting products and consumers within the store;

FIG. 5 shows an augmented reality display as viewed from an employee showing a non-loyalty consumer and a loyalty consumer;

FIG. 6 shows an augmented reality display for loyalty/membership card patrons in an airport context;

FIG. 7 is a flowchart displaying the general practices implemented from the time a consumer registers with a loyalty program to the benefits of being a loyalty member in the store; and

FIG. 8 is a flowchart displaying how the merchant might use and categorize a consumer's loyalty information to have their store employees better assist the consumer.

These exemplary figures and embodiments are to provide a written, detailed description of the inventions set forth by any claims that issue from the present application. These exemplary figures and embodiments should not be used to limit any claims that ultimately issue in a patent from the present application.

### DETAILED DESCRIPTION

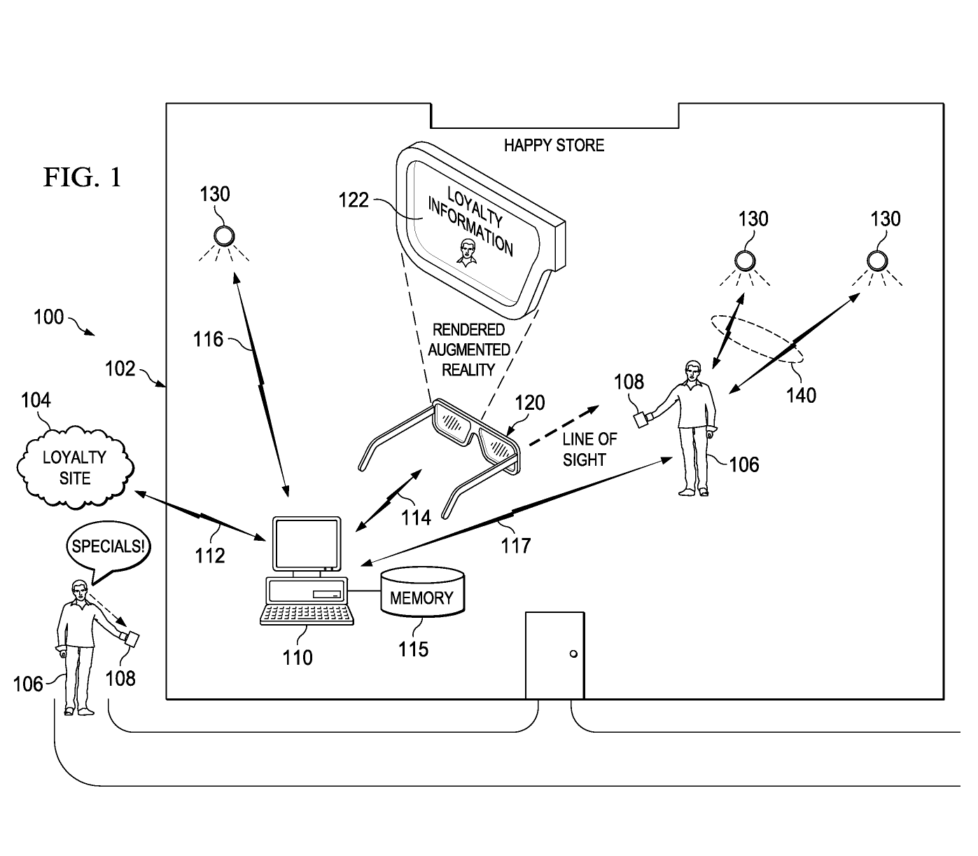

FIG. 1 illustrates, in block diagram form, an embodiment of the disclosed application in which a system 100 is provided to give augmented reality consumer information to a merchant regarding the consumers interacting with the merchant by shopping at a merchant store/location. Although this embodiment is described with respect to a merchant, there are other contexts in which the disclosed systems can be used. By way of example and without exclusion of other embodiments, such systems can be used for customers in an airport or in other service industries. Broadly speaking, the embodiments disclosed in this application provide contextual and real-time information to employees or other associated workers at a retail or service establishment. Identified consumers may be associated with the retail or service establishment's loyalty programs and those programs might have historical shopping information for the consumer based on their background, geography, biological profile, or purchasing history. Such relevant contextual information might be used by a sales associate to improve the shopping experience.

As illustrated in FIG. 1 there is shown a merchant site 102. Outside the merchant site is a consumer 106 who has a portable device 108. In one embodiment, if this consumer's portable device 108 was associated with a loyalty program for the merchant 102, the consumer 106 could check-in at the merchant 102 or otherwise be identified by his presence at the merchant. For example, the portable device 108 might be identified by a Wi-Fi signal, a Bluetooth signal, through the internet, or through the user's GPS mapping or other location functionality within the portable device 108. Within the merchant site 102 is provided a store computer 110.

The store computer 110 is operable to provide overall control of the augmented reality experience for the store's 102 clerks. The store computer 110 is operable to communicate with a loyalty site 104 associated with the merchant 102 through the communications network 112. Within the store could be provided sensors 130 to locate one or more consumers 106 within the store such that the consumer 106 can be tracked.

The augmented reality experience could be an opt-in program, meaning that this would be a service provided to consumers at their voluntary participation in the systems such that the relevant contextual information can be provided to them while they shop, enhancing their shopping experience. The sensors 130 could be operable to locate the consumer within the store through triangulation or other location methods.

To detect and locate consumers, there could be multiple sensors 130 and Wi-Fi, Near Field Communication, or other RF signals emanating from the consumer's portable device 108 which could be used to specifically identify the consumer within the store 102. A GPS signal, if available, could also be used to locate the consumer, although GPS signals oftentimes do not work within building such that sensors 130 or other means would be necessary to locate the consumer.

The store computer 110 would communicate with the sensors 130 to track the consumer's location through the communication link 116. Accordingly, the store computer 110 and the sensors collectively serve as consumer location processing circuitry. Alternatively, the user devices 108 might use internal GPS circuitry and transmit their GPS information directly or indirectly to the store computer 110 through a local communication system such as a Local Area Network (LAN) or using an internet system such as Google Latitude or other internet-connected system that can be configured to keep track of a user's whereabouts.

Also provided under control of the store computer 110 are a number of augmented reality vision devices 120. As shown in the figure, the store computer 110 communicates with these augmented reality devices 120 through communication links 114. Although the store computer 110 is illustrated in FIG. 1 as being at the merchant site 102, it could be remotely connected to another computer or other systems in the store or service location 102, or it could be a cloud-based computing resource remotely controlling the in-store systems.

In the illustrated embodiment of FIG. 1, the augmented reality devices are shown as augmented reality glasses 120 in which a store clerk wearing the glasses 120 would see actual events in the store normally through the glass portion of these devices, but superimposed on the glasses in view of the store clerk would be information about the in-store consumer. The information would be presented in a contextually relevant way, such as being juxtaposed on the augmented reality display above the view of the consumer. The store computer 110 is thus able to display relevant information about the consumer in that context because the system keeps track of the consumer's location and knows about the consumer's buying habits and trends from the loyalty program.

As an overall part of the system operation, the store computer 110 keeps track of the consumer and is able to detect where the augmented reality devices 120 are focused and when they are directed toward a particular consumer. Additionally, the store computer 110 could also have within its associated memory 115 a database including a store map and lists of products and product locations whereby the contextually relevant information displayed to the store clerk can include highlighting contextually relevant products in near proximity to the consumer or within the field of display of the augmented reality device 120. Illustrated in the display inset 122 is a simplified representation of an augmented reality display. This is a representation of what the store clerk or other user of the augmented reality devices 120 would see on those displays 122.

Other possible embodiments of the augmented reality devices 120 could be any type of device that has a camera (or receives a captured video image) and displays (or otherwise provides a sensory output to an integrated or external user interface) that shows both captured images and superimposed contextually relevant information that could be used by a clerk or other employee. The clerk or other employee might be able to view the device display 122 and the camera image on the display 122 could be augmented with the previously discussed loyalty and customer and product information. As mentioned the consumer 106 has a portable device 108 and it is also envisioned that the store computer 110 would be in communication with the device 108 through the communication link or communication network 117 using communications technologies including the internet, Wi-Fi, Bluetooth, or the like. As illustrated in FIG. 1 the location information is gathered by the sensors 130 and is represented in FIG. 1 by the signals 140 of the sensors communicating with the portable device 108.

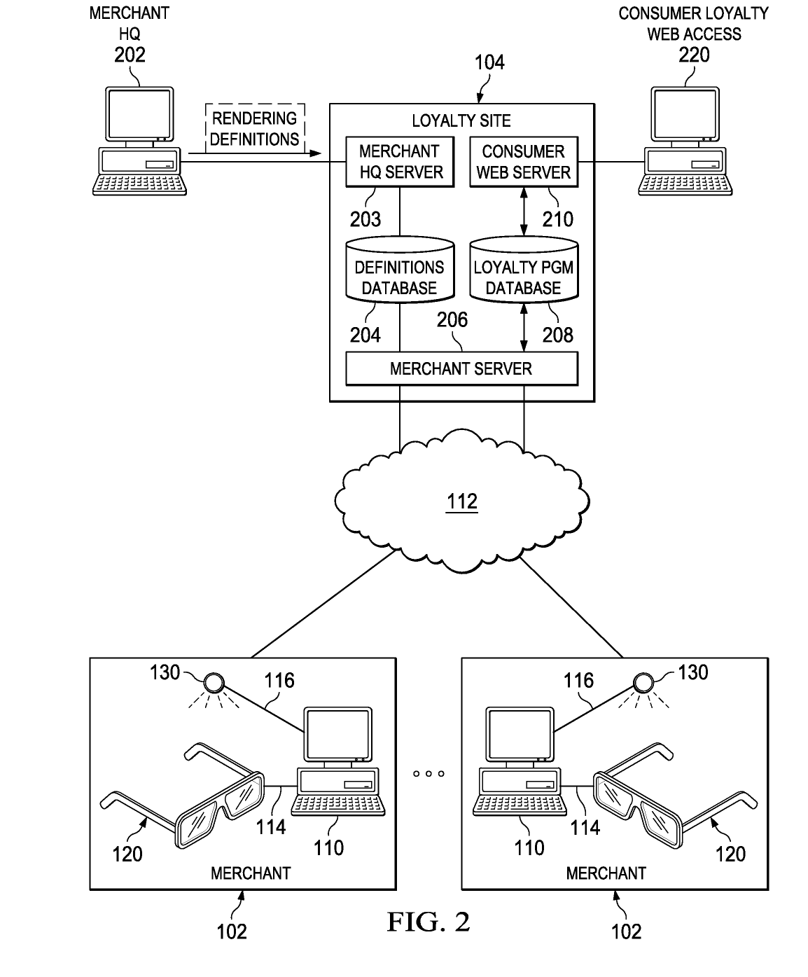

Further shown in FIG. 1 (and further described in FIG. 2 below) is the loyalty site 104, which is in communication with the store computer 110 through the communication network 112. Through the loyalty site 104, the merchant headquarters is able to define different screens that would show up on augmented displays 122. The merchant headquarters would also be able to organize different types of promotions that a consumer 106 in a store might be exposed to through the augmented reality interactions with the store clerk and further would provide things like the loyalty database and consumer information that would be used to provide contextually relevant information to a consumer. For instance, if a consumer historically buys a lot of sporting goods in a store, the store clerk's augmented reality displays 122 could be operable to present sporting goods offers available to the consumer or otherwise indicate that interest. Another consumer, for example, might be interested in music or movies, and the loyalty site would know about these preferences and be able to tailor contextually relevant augmented reality offers to be presented to the consumers by the in-store representatives based on that knowledge.

FIG. 2 more specifically illustrates an architectural diagram of an exemplary system in accordance with the embodiments described in this application. Although throughout this application certain exemplary embodiments are described using exemplary technology and devices, it should be appreciated that such embodiments could be implemented in multiple ways. One of ordinary skill in the art would understand how to implement multiple variations based on the disclosures provided herein.

Illustrated in FIG. 2 in greater detail is the loyalty site 104 that was previously mentioned in FIG. 1. Within the loyalty site 104 is provided a merchant headquarters' server 203 which provides an interface to the merchant headquarters' computer system 202. Through the merchant headquarters' computer system 202, an administrator of the loyalty program can provide, as mentioned previously, different renderings of screen images to be presented through the augmented reality displays 122. That same administrator of the loyalty program can provide various offers and define the context and conditions under which these offers would be presented to targeted consumers 106.

The sales programs, renderings, and other concepts developed by the administrator of the loyalty program can be types of definitions and preferences can be stored within the definitions database 204 which is also in communication with the merchant server 206. In turn, the merchant server 206 can provide the definitions and preferences through its communication to the store computer 110 at multiple merchant sites 102. In this way, each of the merchant sites 102 can receive, upon demand or through mirroring of the relevant information stored at the loyalty site 104, the information relevant that will enable the store computers to provide the relevant contextual offers or other information for the consumers that are in the store such that the store employees will have that information in their augmented reality displays 122.

As previously described, the store employees will be able to provide contextually relevant information in part because the sensors 130 will keep track of the consumers' location relative to the products/services being provided in the merchant location. The store computer 110 will accordingly provide that relevant information to store clerks and other employees using the augmented reality glasses or other augmented reality devices 120. This communication between the merchant server 206 and store computer 110 would be through a communications network 112 which could be a secure internet connection established through secure protocol internet communications, although other types of communication networks 112 are possible. As illustrated in FIG. 2 the communication with the merchant site 102 from the merchant server 206 within the loyalty site 104 is to multiple merchants and this, depending on how the loyalty program is defined, could span different merchant entities as well as being defined to a single merchant entity depending on whether a loyalty site encompasses multiple different merchant entities or not.

Further provided within the loyalty site 104 is a consumer web server 210 through which a consumer can access their personal account with the loyalty site 104. Through the consumer's personal account the user can further help define offers of interest to them and provide perhaps coupons or other offers that might be presented to the user upon entering a merchant 102. This loyalty program information relevant to the consumer would be stored in loyalty program database 208 which tracks such things as what portable devices 108 are associated with the consumer 106, as well as the previously mentioned purchasing profiles and preferences of the consumers. The communication of the loyalty program database 208 with the consumer's portable device 108 would typically be through the internet. The consumer would typically access the consumer web server 210 through the internet on one of their personal devices 220 which could actually be the same device as the portable device 108 that would be web-enabled.

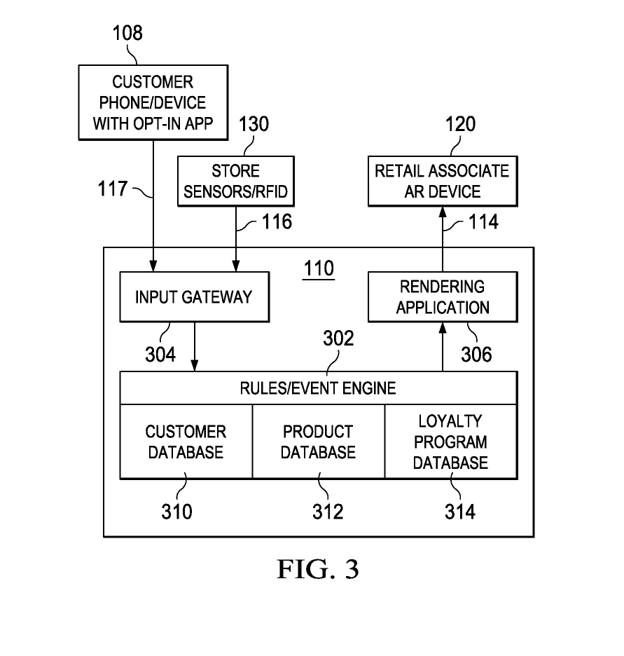

FIG. 3 is a block diagram focusing primarily on the store computer 110 and on computer system elements that would be located within the store computer 110. For example, as discussed previously, the store computer 110 interfaces with the customer's portable device 108 through a communications network 117. The input gateway 304 is provided as a communications interface for the store computer 110. This input gateway 304 is also operable to provide the interface to the store sensors/RFID sensors 130 that might be provided within the store location.

Further provided within the store computer 110 is a rules/event engine 302 that performs the main processing of the consumer's preferences, the consumer's location, and the product layout within the store. The contextual information about where the consumer is located within the store, and the consumer's known preferences through the loyalty database can be provided by the store computer 110. This rules/event engine 302 will draw on things like the customer database 310, the product database 312, and the loyalty program database 314 to provide this contextually relevant information. The rendering application 306 provides a graphical juxtaposition of the augmented reality information upon the display superimposed with the actual images that either a camera on a personal device or a pair of glasses as directed within the store or through some other type of augmented reality device 120 that is known in the art. The communication from the rendering application 306 is provided (via communications path 114) to this retail associate's augmented reality device 120 such that the clerk or other store employee is able to provide enhanced service to the customer using the augmented reality information.

With further reference to FIG. 3 the various elements shown within the store computer 110 may or may not be actually located within the store computer 110. In fact, other embodiments available would be to include these databases at the loyalty sites 104 such that only partial information would be needed to be drawn from the cloud-based loyalty program. The database information could be mirrored within a particular merchant site 102 such that in the event of a disconnection or loss of communication with the loyalty site 104, the local store computer 110 would still be able to provide the same relevant contextual information. At any rate, this application is meant to encompass any arrangement of the various data sites and processing engines or machines that will accomplish the described embodiments without regard to where those different elements are located.

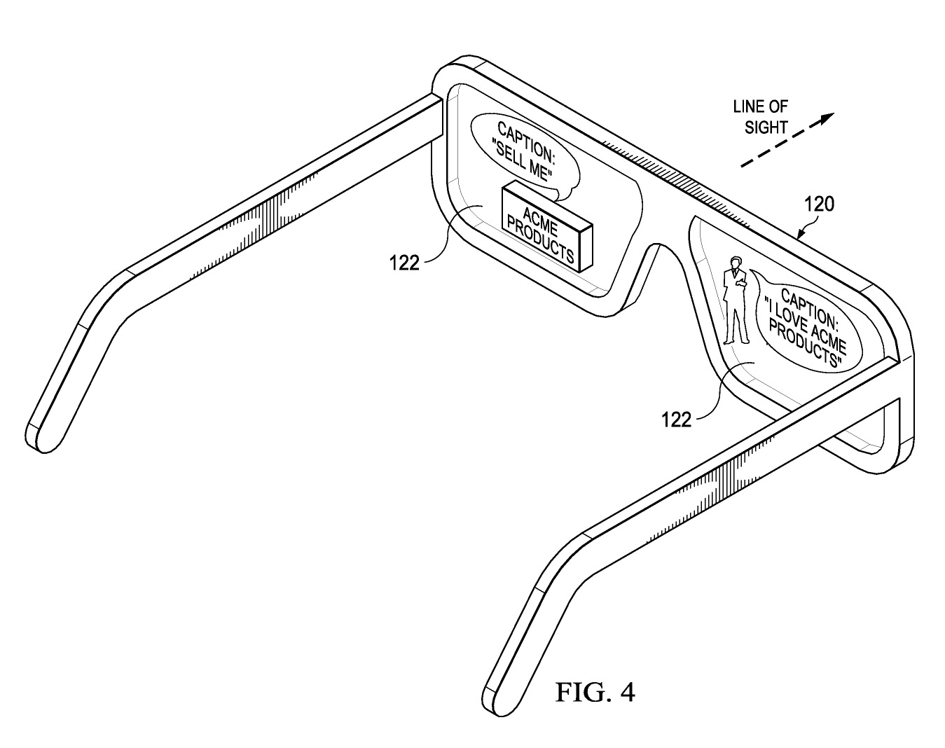

FIG. 4 is a representation of a possible augmented reality display 122 as viewed from a store clerk using augmented reality glasses 120. Through this augmented reality display 122 the clerk may be able to identify specific information about products and loyalty customers. The augmented reality display 122 may also be able to give contextually relevant information about the loyalty customer and the products of interest to the customer. In this representation of the augmented reality display, the loyalty customers are seen in the “real reality,” i.e., in actual real-time image or directly through glasses, while the information about the loyalty customer 106 is shown superimposed over the “real reality.” Such superimposed items might include an asterisk or other indicator above the loyalty customer, identifying that customer and their information to the store clerk. The products may be shown in the real reality or the products may be superimposed with a customer to show items that may be of interest to the loyalty customer to the clerk.

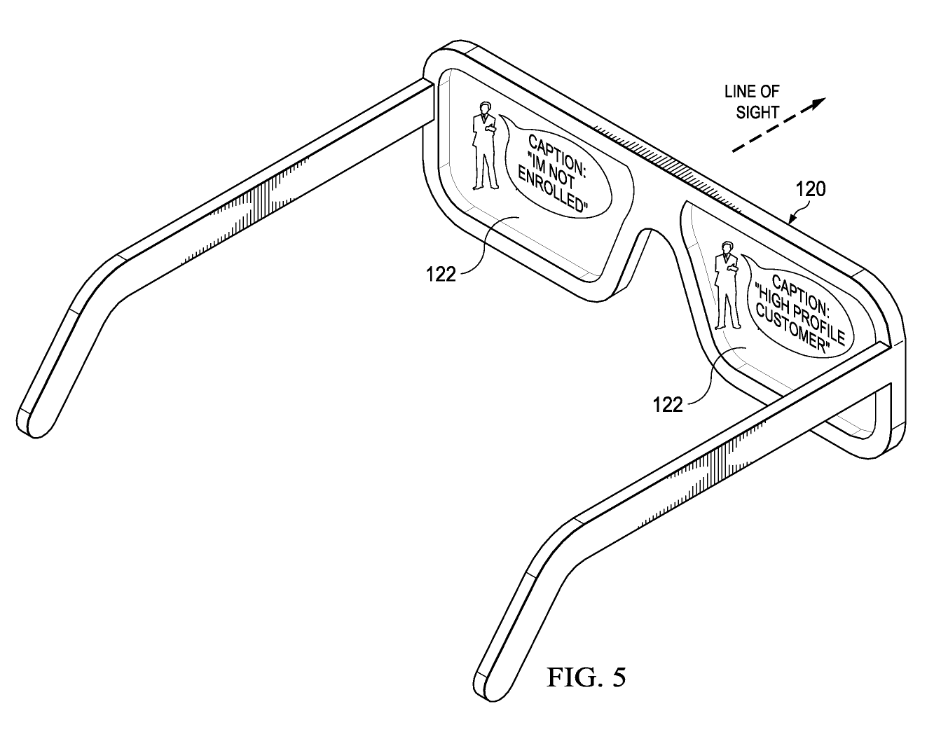

FIG. 5 shows another possible augmented reality display 122 as viewed by a store clerk using augmented reality glasses 120. This augmented reality display 122 might help the store clerks distinguish between loyalty customers and non-loyalty customers. The loyalty customer is shown in this example with an indication that they are enrolled in the loyalty program, whereas the non-loyalty customer is shown in this example with a captain indicating they are not enrolled in a loyalty program. By being able to quickly identify customers as loyalty or non-loyalty customers, a store clerk can be given contextually relevant information on the loyalty customer 106 and in turn enhance the shopping experience of the loyalty customer. As for the non-loyalty customer, the store clerk can try to sign up the non-loyalty customer so that that the non-loyalty customer can have an enhanced shopping experience as well.

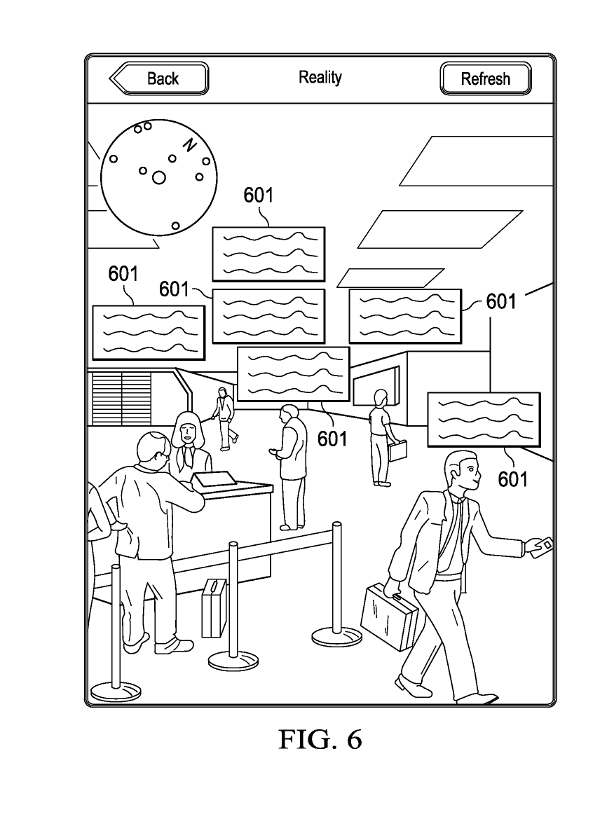

FIG. 6 shows another possible augmented reality display 122 using a portable device with a camera. In this display, an airline employee is able to see the gates and flight information 601 as “bubbles” or other captions above its loyalty members. By being able to have the gates and flight information of loyalty members 601 readily available and displayed for the airline employee, the loyalty member 601 can have an enhanced experience and interaction with the airline employee. It would also be possible to use this approach to provide augmented reality information about frequent airport customers or other persons at the airport. This embodiment is provided as another exemplary embodiment—the concepts disclosed and claimed in the present application can be applied in many different contexts.

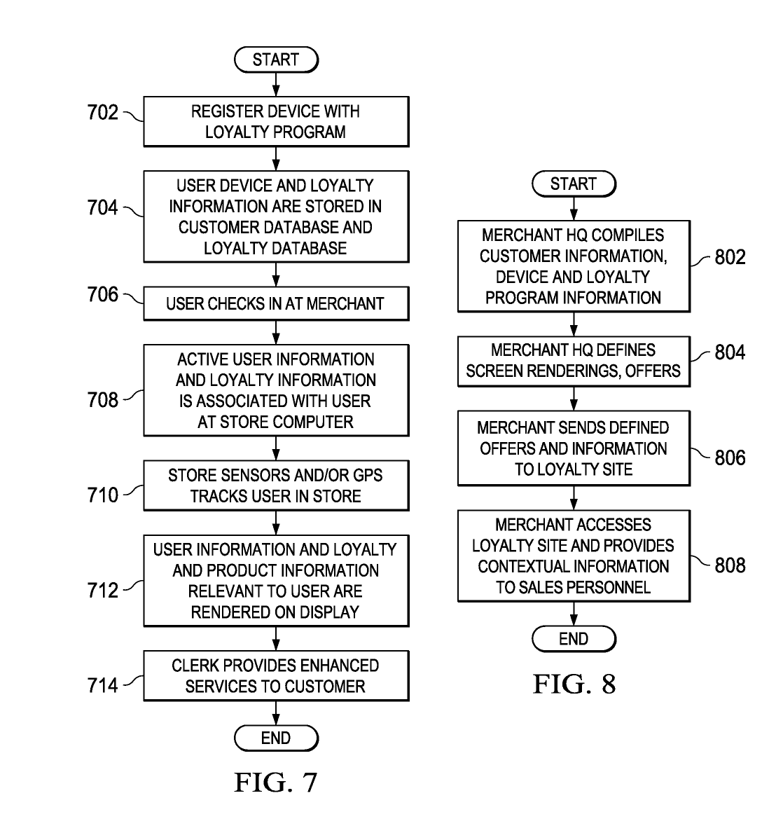

FIG. 7 shows the process for a customer interaction with the disclosed system 100. This exemplary process illustrates the customer joining the merchant's loyalty program and registering their device with the program (at action 702). Once a customer becomes a loyalty member and registers their portable device 108, their information will be stored in the customer and loyalty databases 310, 314 (at action 704). After the customer 106 checks in (at action 706) at a merchant 102 or otherwise becomes detected at the merchant 102, the customer's information will become associated (at action 708) with the store computer 110 at that location 102. The store sensors 130 can be used to track the customer 106 within the store (at action 710) and the employees will get contextually relevant real-time information through their virtual reality devices 120 about the customer in the store (at action 712) to ensure the customer gets an enhanced shopping experience (at action 714).

FIG. 8 shows how the merchant headquarters' computer system 202 might use the loyalty customer information starting with the merchant headquarters' computer system 202 gathering information about the customer 106 and their devices 108 (at step 802). Once the merchant headquarters' computer system 202 has the customer information, the merchant headquarters' computer system 202 can define how to display and present the customer information to the merchant sites 102, as well as what offers to give to certain loyalty customers (at action 804). After the merchant headquarters' computer system 202 defines how to display the loyalty customer information and what offers to give to the loyalty customers 106, the specifications can be sent to the loyalty site (at action 806) which in turn can be read by the merchant site 102. Thus, at action 808, the store computers 110 can provide contextually relevant information and offers relating to the loyalty customers 106 to the clerks or other sales personnel in the store through their respective augmented reality devices 120 to enhance the loyalty customer's experience.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

For example, as referred to herein, a machine or engine may be a virtual machine, computer, node, instance, host, or machine in a networked computing environment. Also as referred to herein, a networked computing environment is a collection of machines connected by communication channels that facilitate communications between machines and allow for machines to share resources. Network may also refer to a communication medium between processes on the same machine. Also as referred to herein, a server is a machine deployed to execute a program operating as a socket listener and may include software instances.

Resources may encompass any types of resources for running instances including hardware (such as servers, clients, mainframe computers, networks, network storage, data sources, memory, central processing unit time, scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and software infrastructures configured to form a virtual organization comprised of multiple resources which may be in geographically disperse locations.

Although various computer elements have been illustrated herein as single computer servers or machines, such elements may operate over several different physical machines, or they may be combined as operating code instances running on a single physical machine. The claims in the present application comprehend such variation in physical machine configurations, and in fact such computers can be virtual or cloud-based computing resources operable to control systems local to or remote from such controlled systems.

Various computer elements have been illustrated herein as single computer servers or machines, such elements may operate over several different physical machines, or they may be combined as operating code instances running on a single physical machine. The claims in the present application comprehend such variation in physical machine configurations.

Various terms used herein have special meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” such claims should not be limited by the language chosen under this heading to describe the so-called technical field. Further, a description of a technology in the “Background” is not to be construed as an admission that technology is prior art to any invention(s) in this disclosure. Neither is the “Brief Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A system for providing contextual information in a display to sales or service personnel in a retail or service location, wherein the contextual information is placed in juxtaposition to real-world image information, the system comprising:
a) a store computer, the store computer operable to communicate with an image display device configured to display current location images and to provide the contextual information for display along with the current location images;
b) a program database that stores consumer preferences;
c) a rules/event engine in communication with the store computer, the rules/event engine operable to process the consumer preferences and to contextually associate the consumer preferences with the current location images;
d) consumer location processing circuitry for communicating with consumer location devices, whereby the store computer is operable to provide the contextual information in relation to the consumers' locations;
whereby the store computer receives the contextual information from the rules/event engine and receives the consumers' locations from the consumer location processing circuitry, and whereby the store computer is operable to provide the contextual information to the image display device in context with the consumers' locations.

2. The system of claim 1 wherein the image display device comprises augmented reality glasses.

3. The system of claim 1 wherein the image display device comprises an electronic video display.

4. The system of claim 1 wherein the sales or service personnel are retail salespersons in a retail store, wherein the program database is a loyalty program database, and wherein the contextual information displayed on the image display device comprises information based on consumer preferences juxtaposed with items for sale in the retail store.

5. The system of claim 1 wherein the consumer location processing circuitry includes sensors for detecting RF signals emanating from consumer portable devices.

6. The system of claim 5 wherein the consumer location processing circuitry uses triangulation to determine positions of the consumer portable devices.

7. The system of claim 1 wherein the consumer location processing circuitry uses GPS information from the consumer portable devices.

8. The system of claim 7 wherein the GPS information is transmitted directly from the consumer portable devices to the consumer location processing circuitry.

9. The system of claim 7 wherein the GPS information is accessed by the consumer location processing circuitry through an internet system.

10. The system of claim 1 wherein the store computer is further operable to able to detect when one of the augmented reality devices is directed towards a particular consumer.

11. The system of claim 10 wherein the store computer is located remotely from the retail or service location and is operable to communicate with the image display device remotely from the image display device.

12. The system of claim 11 wherein the store computer is a cloud-based computing resource.

13. The system of claim 10 wherein the store computer is operable to receive database information comprising a store map including products and product locations and to display the contextually relevant information near the consumer when the consumer is detected to be near to the product locations.

14. The system of claim 13 wherein the product is a service.

15. A system for providing contextual information in a display to sales or service personnel in a retail or service location, wherein the contextual information is placed in juxtaposition to real-world image information, the system comprising:
a) a store computer, the store computer operable to communicate with an image display device configured to display current location images and to provide the contextual information for display along with the current location images;
b) a rules/event engine in communication with the store computer, the rules/event engine operable to process consumer preferences stored in a consumer database and to contextually associate consumer preferences with the current location images;
c) consumer location processing circuitry for communicating with consumer location devices, whereby the store computer is operable to provide the contextual information in relation to the consumers' locations;
whereby the store computer receives the contextual information from the rules/event engine and receives the consumers' locations from the consumer location processing circuitry, and whereby the store computer is operable to provide the contextual information to the image display device in context with the consumers' locations.

16. A method for providing contextual information to sales or service personnel in a retail or service location, the method comprising:
a) providing a store map having a store layout including the placements of certain products or services in the store, the store map being stored in a computer accessible database;
b) gathering through consumer location processing circuitry at least one consumer location relative to the placements of the certain products or services in the store;
c) accessing from a database product or service preferences associated with the at least one located consumer;
d) computing through a rules/event engine contextual information to be placed in juxtaposition to real-world image information and in accordance with the location of the at least one consumer relative to the placements of certain products or services in the store; and
e) displaying the contextual information on image display devices used by the sales or service personnel in juxtaposition to the real-world image information.

17. The method of claim 16 wherein the image display device comprises augmented reality glasses.

18. The method of claim 16 wherein the image display device comprises an electronic video display.

19. The method of claim 16 wherein the consumer location processing circuitry is operable to gather the at least one consumer location by accessing the at least one consumer's GPS information through network communications within the store.

20. The method of claim 16 wherein the consumer location processing circuitry is operable to gather the at least one consumer location by accessing the at least one consumer's GPS information through an internet system.
